(19) United States
(12) Patent Application Publication
(10) Pub. No.: US 2026/0070351 A1
(43) Pub. Date: Mar. 12, 2026

(54) PRINTING APPARATUS

(71) Applicant: CANON KABUSHIKI KAISHA, Tokyo (JP)

(72) Inventors: HIROSHI NAKAI, Kanagawa (JP); SHUICHI TOKUDA, Kanagawa (JP); TAKASHI SASAKI, Kanagawa (JP); KENTO TAMARI, Saitama (JP); MOTOYUKI TAGUCHI, Tokyo (JP); TAKESHI SEKINO, Kanagawa (JP)

(21) Appl. No.: 19/326,192

(22) Filed: Sep. 11, 2025

(30) Foreign Application Priority Data
Sep. 11, 2024 (JP) 2024-157733
Sep. 11, 2024 (JP) 2024-157735

(51) Int. Cl. B41J 11/00; B41J 29/13

(52) U.S. Cl. CPC B41J 11/006; B41J 11/0045; B41J 11/007; B41J 11/0095; B41J 29/13

(57) ABSTRACT

A printing apparatus, comprises a housing including an opening at an upper portion, a printing unit arranged in the housing, a guide mechanism arranged in the housing and configured to guide a sheet from the printing unit, and a cover portion configured to move between a first position at which the opening is opened and a second position at which the opening is closed, wherein the guide mechanism includes a first guide portion for guiding a first surface of the sheet, and a second guide portion for guiding a second surface of the sheet, arranged to face the first guide portion, and the first guide portion is movable to open a conveyance path of the sheet formed between the first guide portion and the second guide portion in a case where the cover portion is at the first position.

### BACKGROUND

### Field of the Technology

The present disclosure relates mainly to the structure of a printing apparatus.

### Description of the Related Art

In a printing apparatus such as an inkjet printer, it is sometimes necessary to access the inside of the apparatus main body and perform maintenance. A typical example of this is a case where a print medium such as a paper material is not properly conveyed and a jam (paper jam) occurs in the apparatus main body.

Japanese Patent No. 4564377 describes an apparatus structure capable of opening a cover at a discharge portion formed at the upper portion of an apparatus main body and performing jam removal work. In general, a conveyance mechanism for conveying a print medium is relatively complicated. A jammed print medium is caught in any mechanism within the apparatus main body and removal of the print medium is difficult, or the print medium is broken and partially remains in the apparatus main body. In this respect, the structure in Japanese Patent No. 4564377 has room for improvement.

### SUMMARY

The present disclosure implements, by a relatively simple arrangement, a structure capable of more properly and easily performing maintenance of the inside of a printing apparatus.

One of the aspects of the present disclosure provides a printing apparatus, comprising a housing including an opening provided at an upper portion, a printing unit arranged in the housing and configured to print on a sheet, a guide mechanism arranged in the housing and configured to guide the sheet conveyed from the printing unit, and a cover portion configured to move between a first position at which the opening is opened, and a second position at which the opening is closed, wherein the guide mechanism includes a first guide portion configured to guide a first surface of the sheet, and a second guide portion arranged to face the first guide portion and configured to guide a second surface of the sheet, and the first guide portion is configured to be movable to open a conveyance path of the sheet formed between the first guide portion and the second guide portion in a case where the cover portion is at the first position.

Features of the present disclosure will become apparent from the following description of embodiments with reference to the attached drawings. The following description of embodiments are described by way of example.

### BRIEF DESCRIPTION OF THE DRAWINGS

FIGS. 1A, 1B, and 1C are perspective views showing an example of a printing apparatus according to an embodiment;

FIG. 2 is a schematic sectional view showing an example of the internal structure of the printing apparatus;

FIG. 3 is a partial perspective view showing an example of the internal structure of the printing apparatus;

FIGS. 4A, 4B, and 4C are schematic sectional views showing an example of the opening procedures of the internal structure of the printing apparatus;

FIGS. 5A and 5B are schematic sectional views showing the example of the opening procedures of the internal structure of the printing apparatus;

FIG. 6 is a schematic sectional view showing the example of the opening procedures of the internal structure of the printing apparatus;

FIG. 7 is a flowchart showing an example of a control method for making a jam notification;

FIGS. 8A and 8B are schematic sectional views showing an example of the internal structure in the open state;

FIGS. 9A and 9B are schematic sectional views showing another example of the internal structure in the open state;

FIGS. 10A and 10B are schematic sectional views showing another example of the internal structure in the open state;

FIGS. 11A and 11B are schematic sectional views showing another example of the internal structure in the open state;

FIGS. 12A, 12B, and 12C are schematic sectional views showing another example of the opening procedures of the internal structure of the printing apparatus;

FIGS. 13A, 13B, and 13C are schematic views showing an example of the arrangement of a discharge guide mechanism;

FIGS. 14A, 14B, 14C, and 14D are perspective views showing an example of the pivot form of the discharge guide mechanism;

FIGS. 15A, 15B, and 15C are schematic side views showing the pivot form of the discharge guide mechanism from another viewpoint;

FIG. 16 is a schematic view showing an example of the arrangement of the brake/lock mechanism of the discharge guide mechanism;

FIGS. 17A, 17B, 17C, and 17D are schematic side views showing the pivot form of the discharge guide mechanism ; and

FIGS. 18A, 18B, 18C, 18D, and 18E are schematic views for explaining the operation of the brake/lock mechanism.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### <<Overall Arrangement of Printing Apparatus 1>>

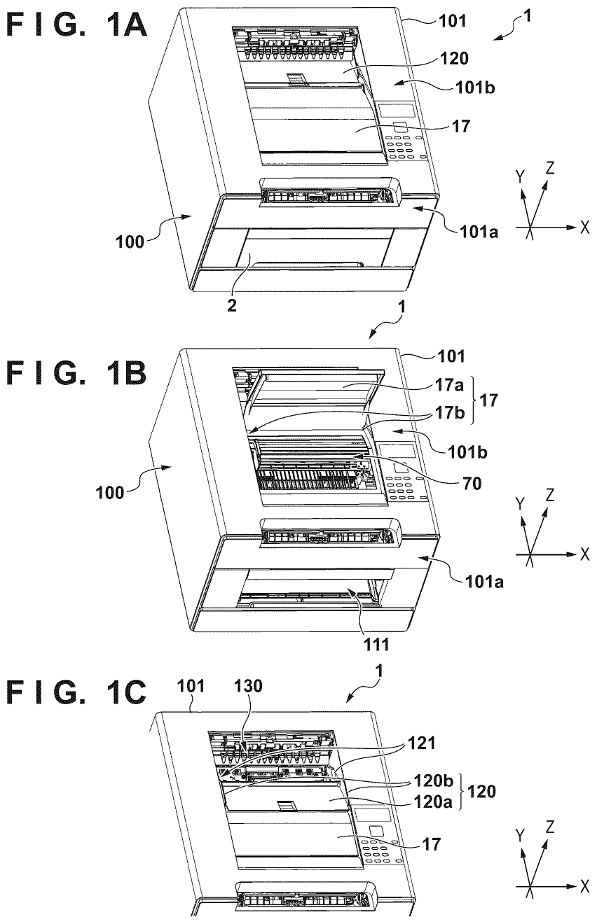

FIG. 1A is a perspective view of an overall printing apparatus 1 according to the first embodiment. In this embodiment, the printing apparatus 1 is an inkjet printer, and includes an apparatus main body 100, a cassette 2, a discharge tray 17, and a discharge tray 120, a detailed operation of which will be described later. The apparatus main body 100 is demarcated by a housing 101, and the cassette 2, the discharge tray 17, and the discharge tray 120 are attached to the apparatus main body 100.

For easy understanding of the structure, X, Y, and Z directions crossing (substantially orthogonal to) each other are shown in FIG. 1A, which also applies to the remaining drawings (to be described later). In this embodiment, the X direction corresponds to the left-and-right direction or the direction of width, the Y direction corresponds to the front-and-back direction or the direction of depth, and the Z direction corresponds to the up-and-down direction or the direction of height. Note that the-X side is the left side, the +X side is the right side, the −Y side is the front side, the +Y side is the back side, the −Z side is the down side, and the +Z side is the up side. In the following description, however, when one side or the other need not be discriminated, a direction will be simply indicated as the X, Y, or Z direction. Both the X and Y directions may be expressed as a horizontal direction, and the Z direction may be expressed as a vertical direction.

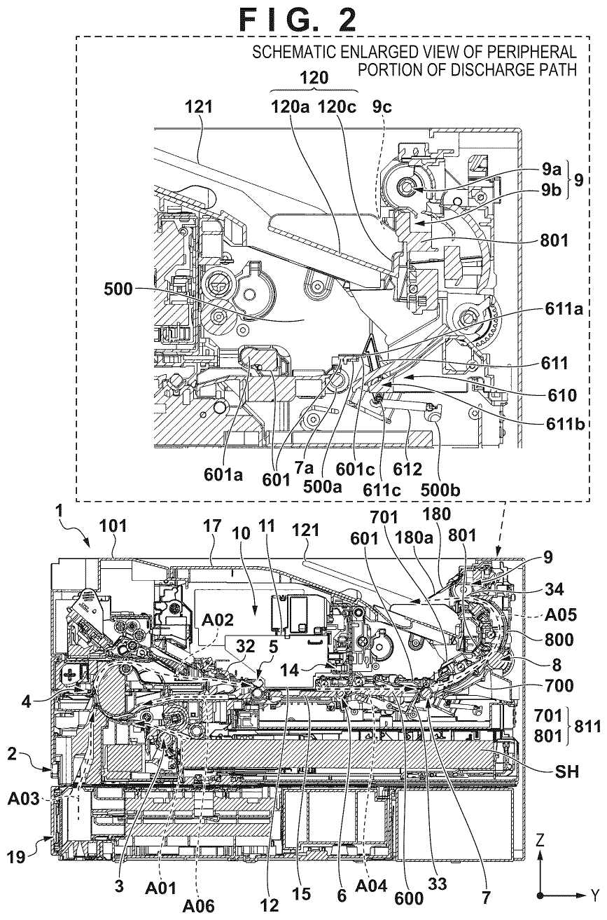

As shown in FIG. 1B, a slot 111 for containing the cassette 2 slidably in the Y direction is provided on a front surface 101a of the apparatus main body 100, and the cassette 2 can be inserted/removed into/from the slot 111. One or more sheets SH (see FIG. 2) are stacked and stored in the cassette 2. The sheet SH suffices to be a sheet-like print medium such as a paper material, and a cut sheet of a size (for example, A4 size) complying with a predetermined standard is typically used as the sheet SH. The cassette 2 may be expressed as a sheet cassette, an accommodation cassette, or the like.

The discharge trays 17 and 120 are provided on an upper surface 101b of the apparatus main body 100, and the sheets SH printed and discharged outside the apparatus main body 100 are placed on the discharge trays 17 and 120. Each of the discharge trays 17 and 120 is so provided as to seal the inside of the apparatus main body 100 to be openable/closable, and the discharge tray 17 is positioned on the −Y side with respect to the discharge tray 120 in the closed state of the discharge trays 17 and 120, details of which will be described later (see FIG. 1A).

As shown in FIG. 1B, the discharge tray 17 includes a plate-like member 17a and shaft portions 17b. The plate-like member 17a is pivotally supported by the shaft portions 17b at ends on the +Y side. With this arrangement, the discharge tray 17 can pivot in the X direction serving as a pivot axis so that an opening 70 at the upper portion of the housing 101 can be opened (see FIG. 1B) or closed (see FIG. 1A). In the closed state (see FIG. 1A) of the opening 70, the plate-like member 17a forms a substantially horizontal surface on the −Y side and forms an inclined surface on the +Y side. The inclined surface is so inclined as to be low on the +Y side and high on the −Y side.

As shown in FIG. 1C, the discharge tray 120 includes a plate-like member 120a and shaft portions 120b. The shaft portions 120b are provided at two end portions (two side portions) of the plate-like member 120a in the X direction. At wall portions of the housing 101 facing the shaft portions 120b, guide rails 121 are disposed to extend along the inclined surface of the plate-like member 17a in the closed state. The shaft portions 120b slidably engage with the guide rails 121. With this arrangement, the discharge tray 120 can slide to the upper portion of the inclined surface of the discharge tray 17 in the closed state so that an opening 130 at the upper portion of the housing 101 can be opened (see FIG. 1C) or closed (see FIG. 1A).

Note that the openings 70 and 130 may be integrally formed at the upper portion of the housing 101. However, for easy understanding, a portion that is opened by pivot of the discharge tray 17 is defined as the opening 70, and a portion that is opened by slide of the discharge tray 120 is defined as the opening 130.

With this arrangement, the user can pivot the discharge tray 17 or slide the discharge tray 120 to relatively easily open and expose the inside of the apparatus main body 100. The user can visually recognize the inside of the apparatus main body 100 through the opening 70 or 130, and access the inside of the apparatus main body 100.

That is, the discharge trays 17 and 120 function as placing portions on which the printed sheets SH discharged outside the apparatus main body 100 are placed, and also function as cover portions that seal the inside of the apparatus main body 100 to be openable/closable. Therefore, both the discharge trays 17 and 120 may be expressed as discharge tray covers. Alternatively, for discrimination, the discharge tray 17 may be expressed as a pivotal cover, and the discharge tray 120 may be expressed as a sliding cover.

### <<Internal Structure of Printing Apparatus 1>>

FIG. 2 is a schematic sectional view showing the internal structure of the printing apparatus 1. The printing apparatus 1 further includes, in the apparatus main body 100, a printing unit 10, a driving unit 14, a platen 15, a plurality of conveyance units 3 to 9, a plurality of sensors 32 to 34, and a flapper 180.

The printing unit 10 includes a carriage 11 and a printhead 12. The carriage 11 supports the printhead 12, and is configured to reciprocate in the X direction so that the printhead 12 can scan in the X direction. A plurality of nozzles are arrayed on a surface of the printhead 12 that faces the platen 15. Each nozzle can discharge ink supplied from an ink tank 19 via an ink tube (not shown).

The driving unit 14 drives the printing unit 10. As an example, the driving unit 14 includes a traveling belt for reciprocating the carriage 11, a pulley for causing the traveling belt to travel, and an electric motor for driving the pulley. With this arrangement, while the sheet SH passes between the printhead 12 and the platen 15, the driving unit 14 reciprocates the carriage 11 to scan the printhead 12, drive the printhead 12 during the scan, and discharge ink from each nozzle. As a result, printing is performed on the sheet SH.

Printing here is formation of an image by discharging ink onto the sheet SH. The concept of an image includes a character, a numeral, a sign, a figure, a photograph, and the like, regardless of whether the image is visible. Although ink is typically a liquid containing dye or pigment, it may be a colorless and transparent reactive liquid or may be expressed as a liquid including them. From this viewpoint, the printing apparatus 1 may be expressed as a liquid discharge apparatus, or the printhead 12 may be expressed as a liquid discharge head.

In this embodiment, printing on the sheet SH is implemented by alternately performing an operation (intermittent conveyance) of conveying the sheet SH only by a predetermined distance and suppressing the conveyance, and an operation (print scanning) of scanning the printhead 12 to print while suppressing the conveyance. The printhead 12 is also expressed as a serial head. As another embodiment, the printhead 12 may be a line head capable of printing at once in the entire area of the sheet SH in the direction of width.

Each of the conveyance units 3 to 9 is arranged at a corresponding position along the conveyance path of the sheet SH represented by an arrow of a broken line in FIG. 2. While clamping the sheet SH together with a driven roller or a driven spur, a driving roller rotates to convey the sheet SH. In this embodiment, the conveyance path mainly extends from the cassette 2 toward the −Y side, while curving upward, extends toward the +Y side and passes through the printing unit 10, and then while further curving upward, extends toward the −Y side and is connected to the discharge port of the sheet SH. The driven roller is arranged on the side of a surface of the sheet SH before printing on which printing is to be performed, and the driven spur is arranged on the side of a surface of the printed sheet SH on which printing has been performed. Each of the driven roller and driven spur is biased and arranged against the driving roller by a biasing means (not shown) so as to be rotatable and contact the corresponding driving roller. Note that the driven spur may be another disk-like rotation member (driven rotation member).

The conveyance unit 3 includes a driving roller and a driven roller that are in contact with each other, and conveys the sheet SH picked up from the cassette 2 (see an arrow A01). Similar to the conveyance unit 3, the conveyance unit 4 includes a driving roller and a driven roller that are in contact with each other, and further conveys the sheet SH conveyed from the conveyance unit 3 (see an arrow A02). Note that the conveyance unit 4 can also receive the sheet SH from an external sheet feed unit additionally attached at the lower portion of the apparatus main body 100, and convey the sheet SH (see an arrow A03).

The conveyance units 5 and 6 can execute intermittent conveyance, and can also execute conveyance at a constant speed. The conveyance unit 5 is arranged on the upstream side in the conveyance direction with respect to the printing unit 10, includes a driving roller and a driven roller that are in contact with each other, and intermittently conveys the sheet SH toward the printing unit 10. The conveyance unit 6 is arranged on the downstream side in the conveyance direction with respect to the printing unit 10, includes a driving roller and a driven spur that are in contact with each other, and further intermittently conveys downward the sheet SH printed by the printing unit 10 (see an arrow A04).

Each of the conveyance units 7 to 9 includes a driving roller and a driven spur that are in contact with each other. The conveyance units 7 to 9 are arranged along a discharge path (or a discharge conveyance path) for discharging, to the apparatus main body 100, the printed sheet SH conveyed from the conveyance unit 6. That is, the discharge path is a path through which the sheet SH can pass from the conveyance unit 6 to the conveyance unit 9, out of the conveyance path of the sheet SH indicated by the arrow A01 and the like. The discharge path is formed to curve so as to pass from a lower back portion to an upper back portion and further pass through a back portion in the apparatus main body 100 (see an arrow A05). The sheet SH is reversed so that the printed surface faces down, and then is discharged onto the discharge trays 17 and 120. This discharge form can be expressed as facedown discharge. In this embodiment, the conveyance unit 7 is arranged at the lowermost position on the curved discharge path, the conveyance unit 8 is arranged at the backmost position, and the conveyance unit 9 is arranged at the uppermost position so that they can be discriminated from each other.

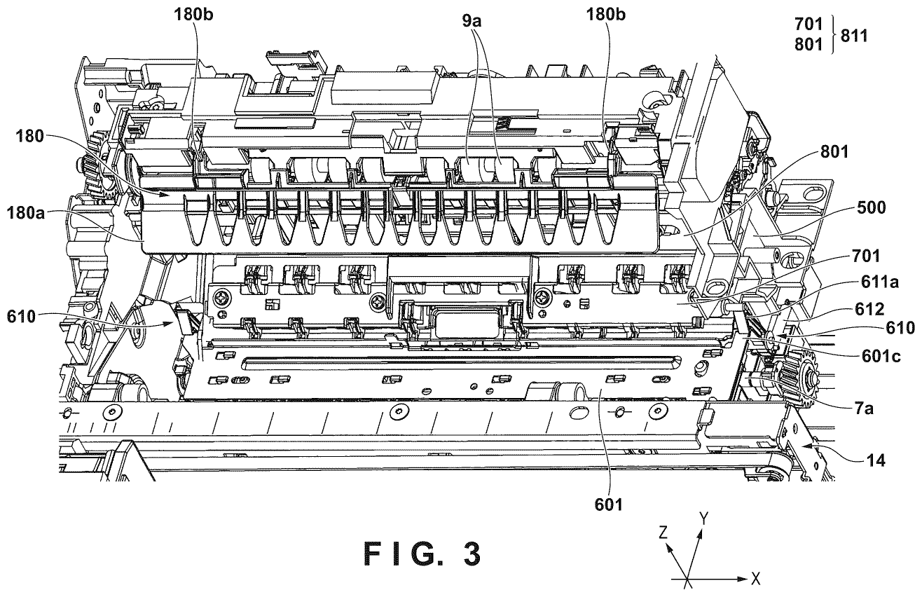

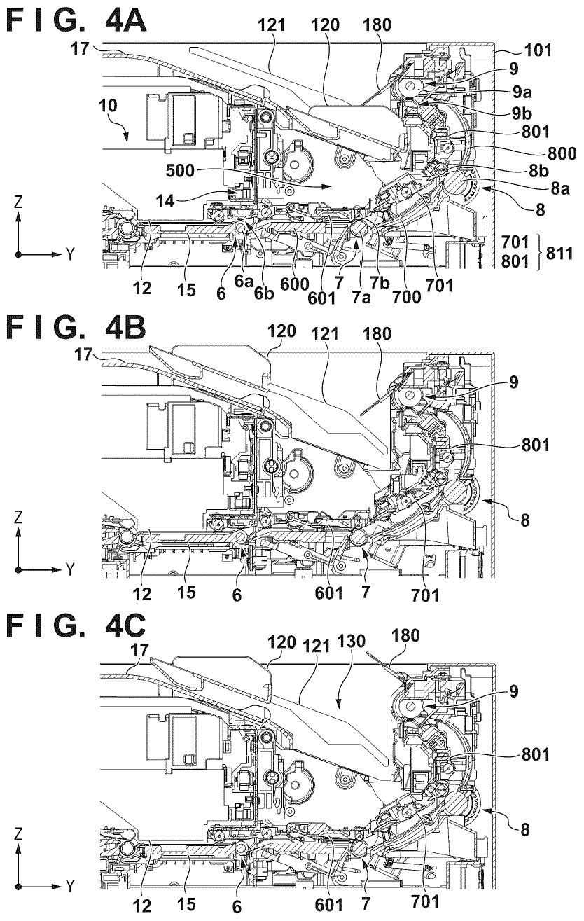

In the conveyance units 6 to 9 arranged on the downstream side of the printing unit 10, the driven spurs are arranged on the side of a printed surface of the sheet SH, and the driving rollers are arranged on the opposite side. The driving rollers of the conveyance units 6 to 9 are shown as rollers 6a to 9a, respectively, and the driven spurs of the conveyance units 6 to 9 are shown as spurs 6b to 9b, respectively (see FIGS. 3 and 4A, and the like).

Note that the above-described conveyance units 3 to 9 may be expressed by other names in accordance with the purpose, application, arrangement position, and the like to discriminate them from each other. For example, the conveyance units 3 and 4 may be expressed as sheet feed units, and the conveyance units 7 to 9 may be expressed as discharge units.

The sensors 32 to 34 are configured to detect the presence/absence of the sheet SH, and can detect, for example, the pass of the leading end (end on the downstream side) and trailing end (end on the upstream side) of the sheet SH. For each of the sensors 32 to 34, a know optical sensor is typically used. The sensor 32 is arranged on the upstream side of the printing unit 10, in this example, on the upstream side of the conveyance unit 5. The sensor 33 is arranged on the downstream side of the printing unit 10, in this example, on the downstream side of the conveyance unit 6 and near the conveyance unit 7. The sensor 34 is arranged on the downstream side of the curved discharge path, in this example, near the conveyance unit 9. The sensors 32 to 34 can specify the position of the conveyance target sheet SH.

A guide portion 601 that guides a printed surface of the sheet SH, and a guide portion 600 that guides the opposite surface are arranged to face each other between the conveyance units 6 and 7, details of which will be described later. Similarly, guide portions 701 and 700 are arranged to face each other between the conveyance units 7 and 8, and guide portions 801 and 800 are arranged to face each other between the conveyance units 8 and 9. In other words, a guide mechanism including the guide portions 600, 601, 700, 701, 800, and 801 forms the curved discharge path, and the guide portions 600, 601, 700, 701, 800, and 801 may be expressed as a discharge guide mechanism at once.

A case where printing is performed on only one surface of the sheet SH has been described above. However, the printing apparatus 1 is configured to further print even on a surface opposite to the printed surface of the sheet SH (so-called double-sided printing is possible). The sheet SH printed on only one surface is temporarily conveyed to the middle of the curved discharge path, then passes through the printing unit 10 by the conveyance units 5 to 9, and is returned to the conveyance unit 4. At this time, the sheet SH is turned over (see an arrow A06). The sheet SH is conveyed again to the printing unit 10, and printing is performed on the other surface of the sheet SH.

From this viewpoint, a surface of the sheet SH on which printing has been finally performed is regarded as an upper surface, and the opposite surface is regarded as a lower surface. The guide portion 601 may be expressed as an upper surface guide portion, and the guide portion 600 may be expressed as a lower surface guide portion so as to discriminate them from each other. Alternatively, the guide portion 601 may be expressed as a one-surface guide portion (or an other-surface guide portion), and the guide portion 600 may be expressed as an other-surface guide portion (or a one-surface guide portion) so as to discriminate them from each other. Based on the internal structure that forms the curved discharge path, the guide portion 601 may be expressed as an inner periphery guide portion, and the guide portion 600 may be expressed as an outer periphery guide portion so as to discriminate them from each other. This also applies to the guide portions 700 and 701, and the guide portions 800 and 801.

Note that when printing is not performed on the other surface after printing is performed on one surface and the sheet SH is turned over, a surface facing the printing unit 10 may be regraded as an upper surface, and the other surface may be regarded as a lower surface.

In the following description, each of the guide portions 601, 701, and 801 is expressed as an upper surface guide portion, and each of the guide portions 600, 700, and 800 is expressed as a lower surface guide portion so as to discriminate them from each other.

The upper surface guide portion 601 is pivotally installed in the apparatus main body 100, details of which will be described later. The upper surface guide portions 701 and 801 are unitized as a downstream-side upper surface guide portion 811, and pivotally installed in the apparatus main body 100.

The flapper 180 is installed to be pivotal about shaft portions 180b (see FIG. 3) serving as pivot shafts at an upper back portion in the apparatus main body 100. The flapper 180 is biased by a biasing means (not shown) so as to take a posture in which a distal end portion 180a faces the discharge trays 17 and 120. When discharging the sheet SH outside the apparatus main body 100, the discharge tray 120 is preferably positioned so that a wall portion 120c at a +Y-side end portion serves as the −Y side with respect to a −Y-side end 9c of the roller 9a, as shown in the schematic enlarged view of FIG. 2. The printed sheet SH discharged outside the apparatus main body 100 is properly placed on the discharge trays 17 and 120. When two or more sheets SH are discharged, they are stacked on the discharge trays 17 and 120.

Note that a sensor (not shown) is provided on the flapper 180. When the distal end portion 180a exceeds a reference, it is determined that the amount of sheets SH stacked on the discharge trays 17 and 120 becomes equal to or larger than a reference. Then, a predetermined notification can be made to additionally interrupt the print operation.

With this arrangement, printing is performed on the sheet SH conveyed by the conveyance units 3 and 4 through intermittent conveyance of the conveyance units 5 and 6 and print scanning of the printhead 12. The printed sheet SH is discharged outside the apparatus main body 100 by the conveyance units 6 to 9, and placed on the discharge trays 17 and 120.

FIG. 3 is a partial perspective view showing the detailed structure of the peripheral portion of the discharge path shown in FIG. 2. Some of the above-described elements are directly or indirectly fixed to an inner side wall 500 of the housing 101, and some other elements are pivotal with respect to the inner side wall 500. For example, in this embodiment, the upper surface guide portion 601 is pivotal about a shaft portion 601a serving as a pivot shaft.

A positioning portion 500a and a fixing portion 500b are provided on the inner side wall 500, and a locking mechanism 610 for locking the upper surface guide portion 601 is attached. The locking mechanism 610 includes a lever unit 611 and a biasing unit 612. The lever unit 611 includes a hook portion 611a, a pivot shaft 611b, and a fixing portion 611c, and is pivotal about the pivot shaft 611b between the hook portion 611a and the fixing portion 611c. The biasing unit 612 is installed between the fixing portions 500b and 611c, and biases the lever unit 611 so that the hook portion 611a is locked by a locking portion 601c. The upper surface guide portion 601 is thus locked at the positioning portion 500a by the lever unit 611 biased by the biasing unit 612. This arrangement is provided on two sides of the housing 101 in the X direction.

### <<Maintenance>>

As described above the user can pivot the discharge tray 17 or slide the discharge tray 120 to open the inside of the apparatus main body 100 and access the inside of the apparatus main body 100. When a jam (paper jam) occurs during conveyance of the sheet SH, the user can pivot the discharge tray 17 or slide the discharge tray 120 to access the inside of the apparatus main body 100 and remove the sheet SH in the jam state (to be referred to as a jammed sheet hereinafter). In this embodiment, a case where a jam occurs while the printed sheet SH passes through the curved discharge path will be explained.

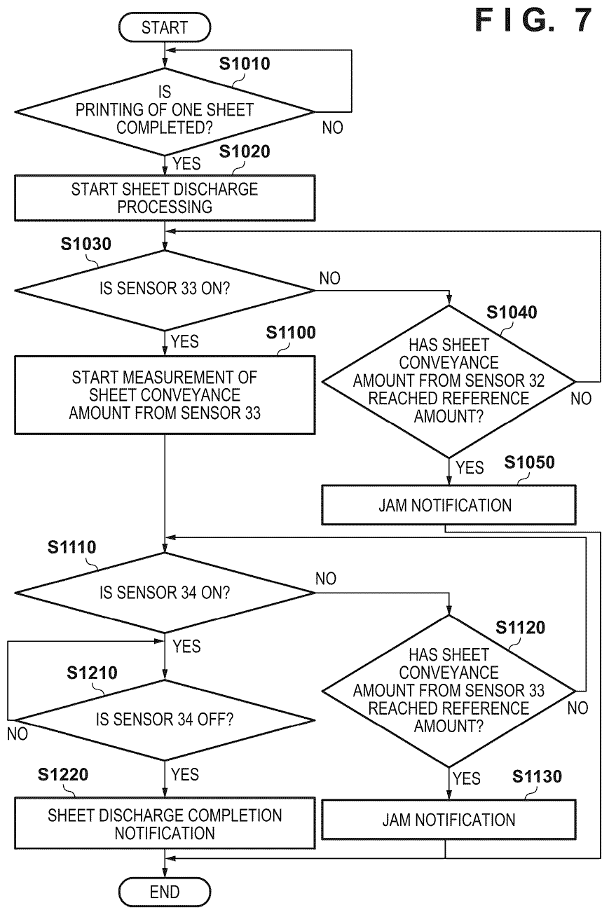

FIG. 4A is a schematic sectional view mainly showing a part including the conveyance path after the printing unit 10, out of the internal structure of the printing apparatus 1. For example, when a jam notification (to be described later: see FIG. 7) is generated, the user can slide the discharge tray 120 to above the inclined surface of the discharge tray 17 along the guide rail 121, thereby opening the printing apparatus 1, as shown in FIG. 4B. At this time, as shown in FIG. 4C, the flapper 180 may be so pivoted as to face upward and be locked by a mechanism (not shown).

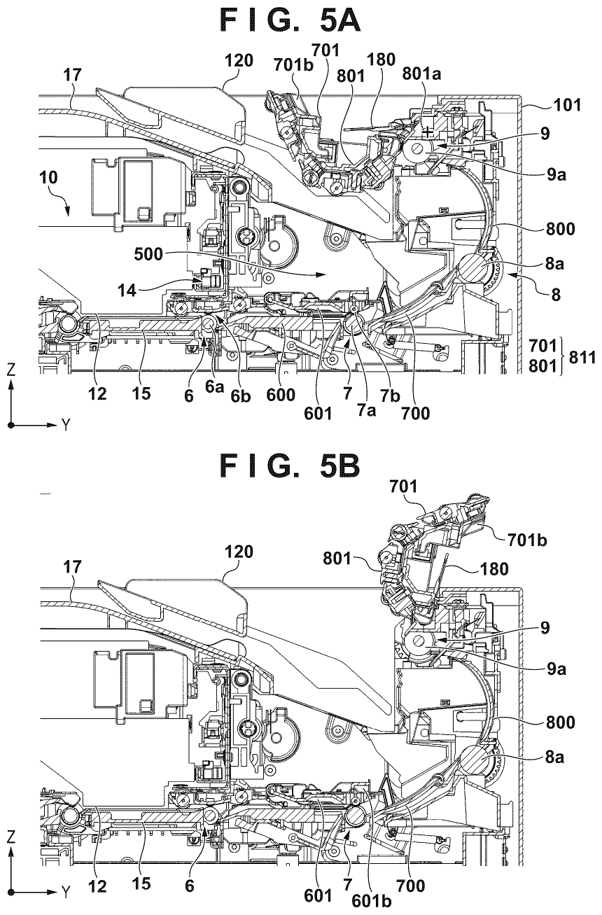

Then, as shown in FIG. 5A, the user can grip a gripping portion 701b provided on the upper surface guide portion 701, and pivot the downstream-side upper surface guide portion 811 (upper surface guide portions 701 and 801) about a shaft portion 801a serving as a pivot shaft. The shaft portion 801a may shift from the rotation shaft of the roller 9a or be coaxial. When the flapper 180 is not pivoted, unlike FIG. 4C, the flapper 180 also pivots along with pivot of the downstream-side upper surface guide portion 811. As shown in FIG. 5B, the downstream-side upper surface guide portion 811 pivots up to the position of the end of the pivotal region, and can be locked at this position.

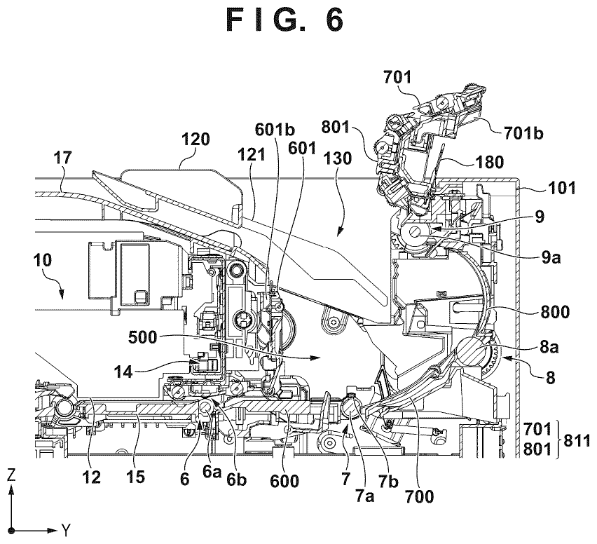

Finally, as shown in FIG. 6, after canceling the locking of the upper surface guide portion 601 by the locking mechanism 610, the user can grip a gripping portion 601b and pivot the upper surface guide portion 601 about the shaft portion 601a (see FIG. 2) serving as a pivot shaft. The upper surface guide portion 601 after the pivot may be held by, for example, a magnet at a position near the driving unit 14. In this manner, the lower surface guide portions 600, 700, and 800 are exposed to open the discharge path of the sheet SH, and the user can remove the jammed sheet SH from the discharge path. According to this embodiment, maintenance of the inside of the apparatus main body 100 can be performed properly and easily.

Note that sensors (not shown) may be provided on the upper surface guide portions 601, 701, and 801, and when one of the upper surface guide portions 601, 701, and 801 is pivoted to open the discharge path of the sheet SH, execution of a print operation may be suppressed or interrupted. After the completion of maintenance of the inside of the apparatus main body 100, the user can return the print operation to a restartable state by operating the respective mechanisms in an order reverse to the above-described order.

FIG. 7 is a flowchart showing an example of a control method for making a jam notification. This sequence can be typically performed by reading out a program by a Central Processing Unit (CPU) built in the printing apparatus 1 and executing it while deploying it in a memory. An outline of the sequence is to specify the discharge form of a sheet based on the detection results of the sensors 32 to 34, and when generation of a jam is detected, making a predetermined notification to the user.

In step S1010 (to be simply referred to as “S1010” hereafter. This also applies to other steps to be described later.), it is determined whether printing of one sheet by the printing unit 10 is completed. If printing is completed, the process advances to S1020; if printing is not completed, returns to S1010.

In S1020, discharge processing of the printed sheet SH starts, that is, the sheet SH is conveyed toward the downstream side by the conveyance units 7 to 9.

In S1030, it is determined whether the sensor 33 is ON. The sensor 33 becomes ON when the sheet SH is detected; otherwise, OFF (this also applies to the remaining sensors 32 and 34). If the sensor 33 is ON, the process advances to S1100; if the sensor 33 is not ON, to S1040.

In S1040, it is determined whether the conveyance amount of sheets SH from the sensor 32 has reached a reference amount. Since printing on the sheet SH is properly completed, the sensor 32 has already become ON. Hence, this determination suffices to be performed based on the measurement result of the conveyance amount of sheets SH after the sensor 32 becomes ON. If the conveyance amount of sheets SH from the sensor 32 has reached the reference amount, the process advances to S1050. If the conveyance amount of sheets SH from the sensor 32 has not reached the reference amount, the process returns to S1030.

In S1050, a notification (jam notification) representing that a jam has occurred is made, and the sequence ends.

In S1100, measurement of the conveyance amount of sheets SH from the sensor 33 (after the sensor 33 becomes ON) starts. This measurement may be performed in parallel to measurement of the conveyance amount of sheets SH from the sensor 32.

In S1110, it is determined whether the sensor 34 is ON. If the sensor 34 is ON, the process advances to S1210; if the sensor 34 is not ON, to S1120.

In S1120, it is determined whether the conveyance amount of sheets SH from the sensor 33 has reached a reference amount.

In S1130, another notification (jam notification) representing that a jam has occurred is made, and the sequence ends.

In S1210, it is determined whether the sensor 34 becomes OFF. If the sensor 34 becomes OFF, the process advances to S1220; if the sensor 34 does not become OFF, returns to S1210.

In S1220, a notification representing the completion of discharge of the sheets SH is made.

In this way, when a jam occurs, a jam notification is made. In accordance with this, the user can access the inside of the apparatus main body 100 and remove the jammed sheet SH. The jam notification in S1050 notifies the user of a jam that has occurred before the sensor 33 becomes ON. The jam notification in S1130 notifies the user of a jam that has occurred after the sensor 33 becomes ON. The contents of these notifications may be different from each other so that the user can recognize a jam generation portion. Note that the jam notification may be made on, for example, a display provided on the upper surface 101b, or made by a warning sound, a voice, or the like.

### <<Upper Surface Guide Portion 601>>

When removing the jammed sheet SH, the user inserts the hand into the opened apparatus main body 100, pulls out the jammed sheet SH from inside the apparatus main body 100 while gripping it, and extracts the jammed sheet SH from the discharge path. The conveyance path is relatively narrow on the downstream side of the printing unit 10. For example, near the conveyance unit 6, the jammed sheet SH may be broken at the time of removal, and partially remain in the apparatus main body 100. An arrangement capable of further easily implementing removal of the jammed sheet SH is required.

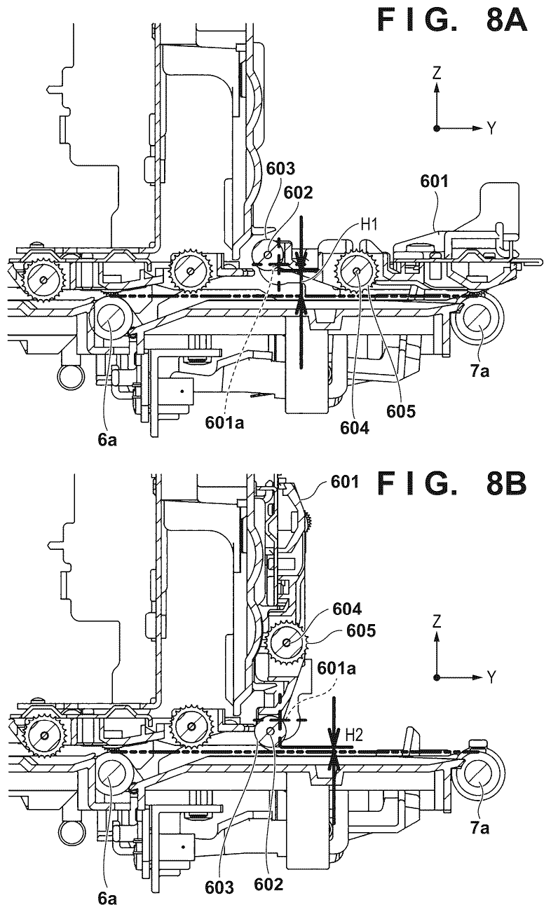

FIGS. 8A and 8B are schematic sectional views mainly showing the conveyance units 6 and 7 and their peripheral portions out of the internal structure of the printing apparatus 1. FIG. 8A shows a state before pivot of the upper surface guide portion 601, and FIG. 8B shows a state after pivot of the upper surface guide portion 601.

In this embodiment, a driven roller 603 and a driven spur 605 are provided on the upper surface guide portion 601. The driven roller 603 can rotate about a shaft portion 602 serving as a rotation shaft, and the driven spur 605 can rotate about a shaft portion 604 serving as a rotation shaft. A plurality of driven rollers 603 and a plurality of driven spurs 605 are provided in the X direction.

As shown in FIG. 8A, the shaft portion 602 is spaced apart from the shaft portion 601a on the −Y side and the +Z side in the upper surface guide portion 601 before pivot, and the driven roller 603 is spaced apart by a distance H1 from the conveyance path of the sheet SH. The shaft portion 604 is spaced apart from at least the shaft portion 601a on the +Y side, and the driven spur 605 is positioned in contact with the conveyance path of the sheet SH. When the upper surface guide portion 601 is pivoted, the driven spur 605 moves apart from the conveyance path of the sheet SH, whereas the driven roller 603 moves close to the conveyance path of the sheet SH up to a distance H2 (H2<H1), as shown in FIG. 8B.

Note that the distances H1 and H2 are distances to the driven roller 603 from tangent lines (ideal conveyance paths or nip lines of the sheet SH) simultaneously passing through the driving rollers 6a and 7a and the corresponding driven spurs 6b and 7b.

With this arrangement, before pivot of the upper surface guide portion 601, the driven roller 603 is not used, and the driven spur 605 can guide conveyance of the sheet SH. After pivot of the upper surface guide portion 601, the driven spur 605 is not used, and the driven roller 603 can guide removal of the jammed sheet SH.

Here, the driven spur 605 is used to guide conveyance of the printed sheet SH during the print operation, whereas the driven roller 603 is used to guide removal of the jammed sheet SH. As the driven roller 603, therefore, a roller made of a resin low in rolling friction and/or sliding friction is preferably used so that the user can easily pull out the jammed sheet SH, and no spur is used.

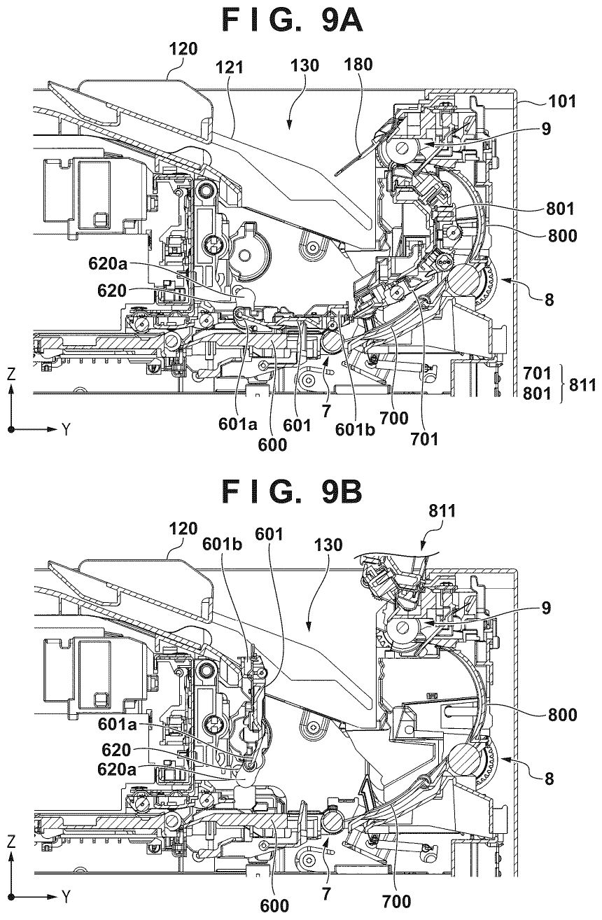

FIGS. 9A and 9B are schematic sectional views showing another example of the pivot form of the upper surface guide portion 601, similar to FIGS. 8A and 8B. In this example, the upper surface guide portion 601 is attached to the inner side wall 500 via a connecting member 620 pivotal at a shaft portion 620a. That is, the connecting member 620 is connected at one end portion to the upper surface guide portion 601 pivotally about the shaft portion 601a serving as a pivot shaft, and connected at the other end portion to the inner side wall 500 pivotally about the shaft portion 620a serving as a pivot shaft. After pivot of the upper surface guide portion 601, the entire upper surface guide portion 601 moves relatively greatly apart from the conveyance path of the sheet SH so that the jammed sheet SH can be relatively easily removed.

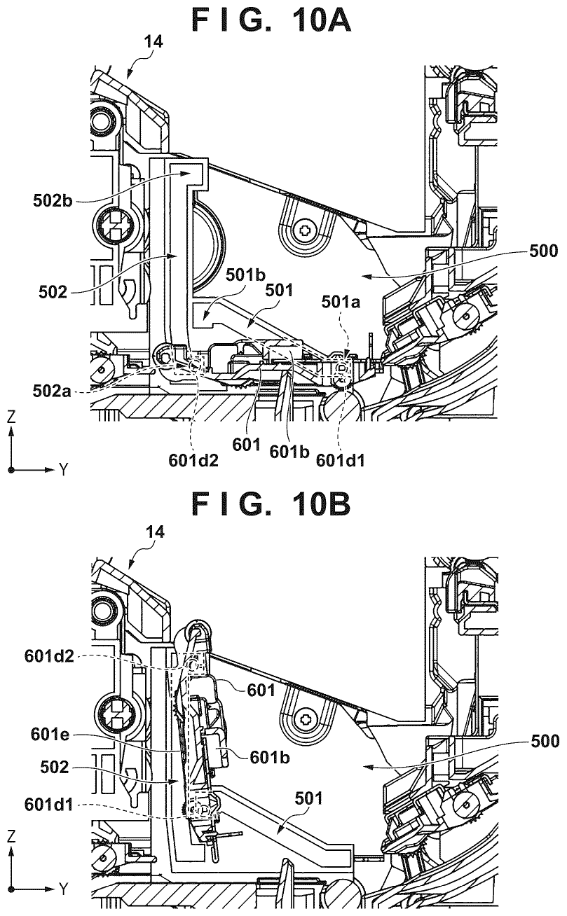

FIGS. 10A and 10B are schematic sectional views showing still another example, similar to FIGS. 8A and 8B. In this example, groove portions 501 and 502 are provided on the inner side wall 500, and the upper surface guide portion 601 is configured to slide along the groove portions 501 and 502 and move apart from the conveyance path of the sheet SH. The groove portion 501 extends from the +Y-side end portion of the upper surface guide portion 601 to the −Y side and the +Z side, and at the two end portions, fitting portions 501a and 501b are provided. The groove portion 502 extends from the −Y-side end portion of the upper surface guide portion 601 to substantially the +Z side, and at the two end portions, fitting portions 502a and 502b are provided. A shaft portion 601d1 is provided at the +Y-side end portion of the upper surface guide portion 601, and a shaft portion 601d2 is provided at the −Y-side end portion.

In FIG. 10A, the shaft portions 601d1 and 601d2 are respectively fitted in the fitting portions 501a and 502a, and the upper surface guide portion 601 takes a horizontal posture. In FIG. 10B, the shaft portions 601d1 and 601d2 are respectively fitted in the fitting portions 501b and 502b, and the upper surface guide portion 601 takes a vertical posture. In this fashion, the upper surface guide portion 601 can also be configured to move apart from the conveyance path of the sheet SH by sliding. Even with this arrangement, the jammed sheet SH can be relatively easily removed.

The upper surface guide portion 601 is smaller in size than the above-described downstream-side upper surface guide portion 811 constituted by unitizing the upper surface guide portions 701 and 801. The upper surface guide portion 601 may move apart from the conveyance path by either pivot or sliding, or move apart from the conveyance path along with another movement.

### <<Modification of Upper Surface Guide Portion 601>>

In this embodiment, of the upper surface guide portions 601, 701, and 801, the upper surface guide portions 701 and 801 are unitized as the downstream-side upper surface guide portion 811, and the upper surface guide portion 601 can move apart from the conveyance path of the sheet SH independently of the upper surface guide portions 701 and 801. However, this embodiment is not limited to this. For example, the upper surface guide portions 601 and 701 may be unitized without unitizing the upper surface guide portions 701 and 801.

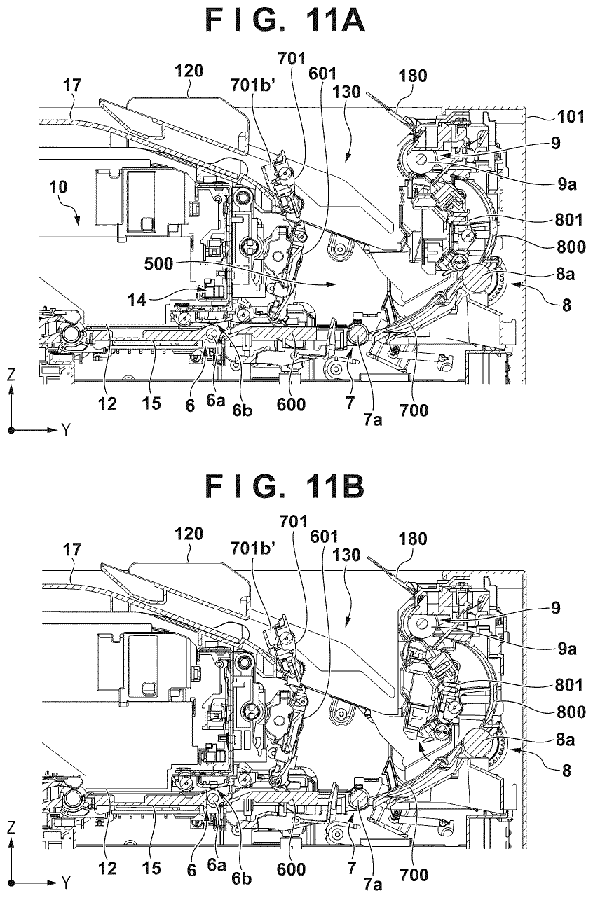

FIGS. 11A and 11B are schematic sectional views in a case where the upper surface guide portions 601 and 701 are unitized. In this example, a gripping portion 701b′ suffices to be provided instead of the gripping portions 601b and 701b.

First, FIG. 11A shows a state in which the unitized upper surface guide portions 601 and 701 are pivoted in a form similar to that in FIGS. 8A and 8B. The upper surface guide portions 601 and 701 after pivot may be held by magnets or the like at positions near the driving unit 14. By the pivot of the upper surface guide portions 601 and 701, most of the discharge path of the sheet SH is opened. The upper surface guide portion 801 need not be pivoted to the outside of the apparatus main body 100, and may be configured to swing within the apparatus main body 100, as shown in FIG. 11B.

With this arrangement, the jammed sheet SH can be relatively easily removed from the discharge path, and the structure around the upper surface guide portion 801 can be simplified.

### <<Modification of Discharge Tray 120>>

In the above-described embodiment, when opening the discharge tray 120, the discharge tray 120 is slid to above the inclined surface of the discharge tray 17 along the guide rail 121 and placed on the inclined surface. However, the embodiment is not limited to this form.

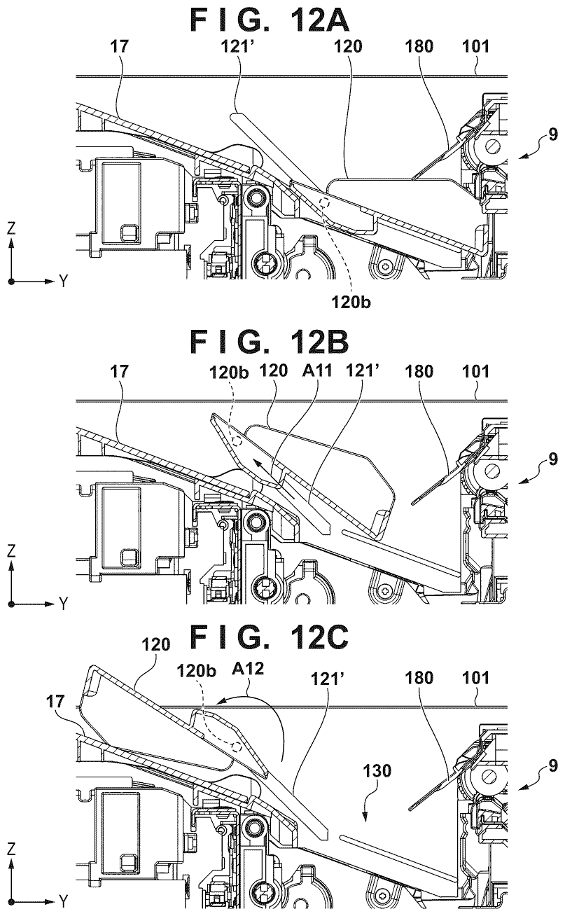

FIGS. 12A to 12C are schematic sectional views showing another example of the structure capable of opening/closing the discharge tray 120. In this example, as shown in FIG. 12A, a guide rail 121′ having a substantially uniform groove width and a small groove length is provided so that it can engage with the shaft portion 120b of the discharge tray 120.

In this arrangement, the discharge tray 120 slides partially (partially on the −Y side) to a position above the inclined surface of the discharge tray 17, as indicated by an arrow A11 in FIG. 12B. Then, as indicated by an arrow A12 in FIG. 12C, the discharge tray 120 is pivoted about the shaft portion 120b serving as a pivot shaft, is turned over, and placed in this posture on the inclined surface of the discharge tray 17. With this arrangement, the shape of the guide rail 121′ can be simplified.

### Second Embodiment

### <<Upper Surface Guide Portions 701 and 801 (Downstream-Side Upper Surface Guide Portion 811)>>

The above-described first embodiment has exemplified the arrangement in which the downstream-side upper surface guide portion 811 constituted by unitizing the upper surface guide portions 701 and 801 can pivot about the shaft portion 801a serving as a pivot shaft (see FIG. 5A).

The size of the downstream-side upper surface guide portion 811 is relatively large, so it can be difficult due to, for example, interference with another mechanism or member to pivot the downstream-side upper surface guide portion 811 to the outside of the apparatus main body 100 via the opening 130. An arrangement is therefore required, in which the pivotal region of the downstream-side upper surface guide portion 811 extends in a predetermined direction and is regulated within a predetermined range.

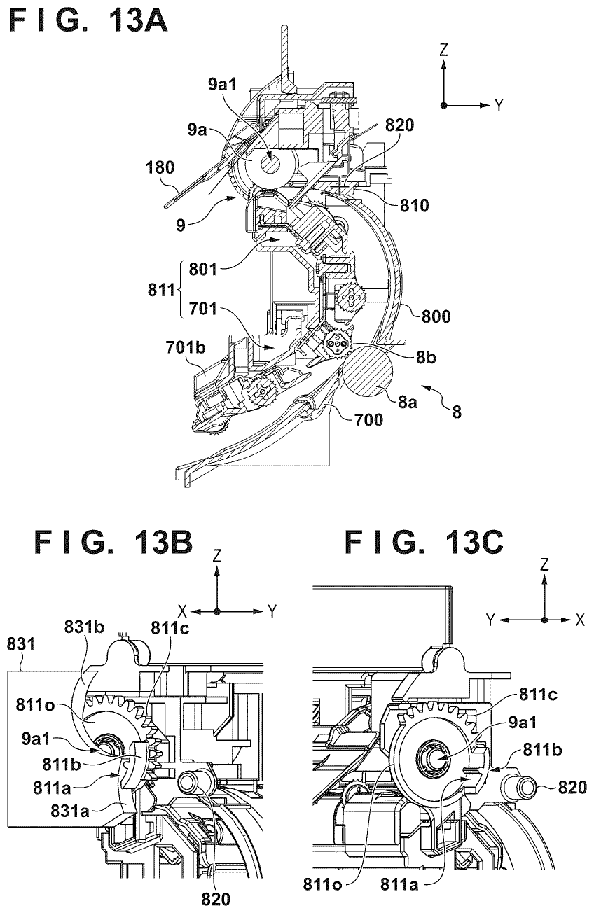

FIG. 13A is a schematic partial sectional view including a downstream-side upper surface guide portion 811 and its peripheral portion. In this embodiment, a support member 810 that supports a conveyance unit 9 and the downstream-side upper surface guide portion 811 and can pivot about a shaft portion 820 serving as a pivot shaft is provided on the downstream side of a lower surface guide portion 800 (in this example, at the upper portion of the lower surface guide portion 800). Note that the support member 810 is a member separate from the lower surface guide portion 800, but forms part of the discharge path of the sheet SH in line with the lower surface guide portion 800 on the downstream side of the lower surface guide portion 800. Thus, the support member 810 may also be expressed as the lower surface guide portion.

FIG. 13B is a perspective view including the downstream-side upper surface guide portion 811 and its peripheral portion. In this embodiment, a circular plate member 811o is attached to the end portion (coaxial with a roller 9a) of a shaft member that rotatably supports the roller 9a. The circular plate member 811o can rotate about a shaft portion 9a1 of the roller 9a serving as a rotation shaft, and the circular plate member 811o and the roller 9a can rotate independently of each other. Cams 811a and 811b and a gear teeth surface 811c are provided at the peripheral portion of the circular plate member 811o, and can rotate about the shaft portion 9a1 serving as a rotation shaft.

Cam surfaces 831a and 831b capable of respectively engaging with the cams 811a and 811b are provided on a guide side wall 831 that is provided as part of an inner side wall 500 or fixed to the inner side wall 500, details of which will be described later. The cam surfaces 831a and 831b form different curved surfaces, and form a top portion at the boundary between them. After the cam 811a slides along the cam surface 831a, the cam 811b can slide along the cam surface 831b, details of which will be described later.

FIG. 13C is a perspective view from another viewpoint without showing the guide side wall 831. The cam 811a is positioned on the inner side of the circular plate member 811o, and the cam 811b is positioned on the outer side of the circular plate member 811o. The gear teeth surface 811c is peripherally provided to correspond to the pivotal region of the downstream-side upper surface guide portion 811, and overlaps the cams 811a and 811b at least partially in the radial direction.

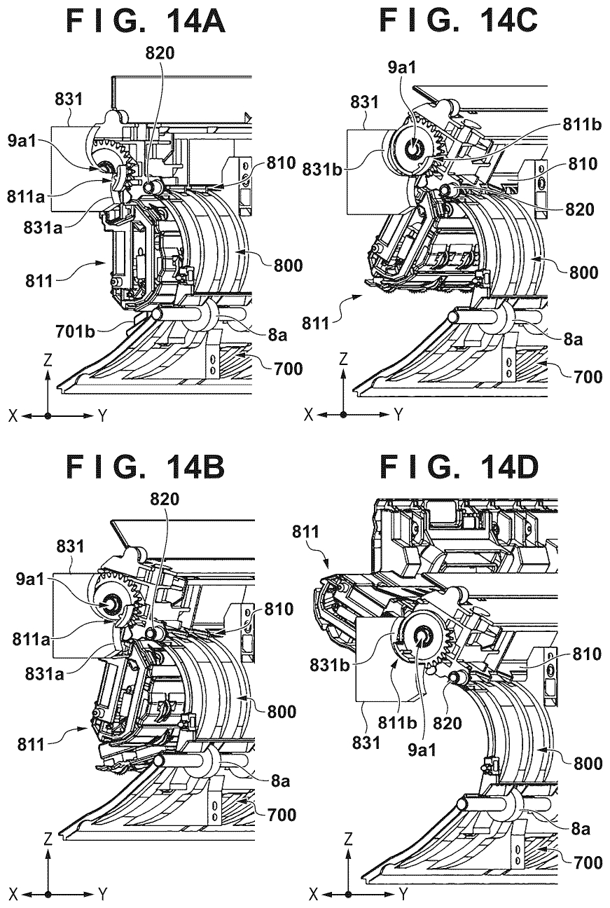

FIGS. 14A to 14D are perspective views for explaining the relative positional relationship between the cams 811a and 811b and the cam surfaces 831a and 831b when pivoting the downstream-side upper surface guide portion 811.

As shown in FIG. 14A, before pivot of the downstream-side upper surface guide portion 811, the cam 811a engages with the cam surface 831a.

As shown in FIG. 14B, when pivot of the downstream-side upper surface guide portion 811 starts, the support member 810 also pivots about the shaft portion 820 serving as a pivot shaft together with pivot of the downstream-side upper surface guide portion 811, and then the conveyance unit 9 also pivots. Meanwhile, the cam 811a slides along the cam surface 831a.

As shown in FIG. 14C, when the downstream-side upper surface guide portion 811 further pivots together with the support member 810, the cam 811a moves to the upper portion of the cam surface 831a. As a result, the cam 811b can slide along the cam surface 831b. At this timing, the pivot of the support member 810 ends.

As shown in FIG. 14D, the downstream-side upper surface guide portion 811 can further pivot about the shaft portion 9a1 serving as a pivot shaft and move up. Meanwhile, the cam 811b slides along the cam surface 831b.

In short, the support member 810 is arranged pivotally about the shaft portion 820 serving as a pivot shaft, and supports the conveyance unit 9 including the shaft portion 9a1 and the downstream-side upper surface guide portion 811. With this arrangement, the downstream-side upper surface guide portion 811 has two pivot shafts, that is, the shaft portions 820 and 9a1, and the two pivot shafts are switched by sliding of the cam 811a and cam surface 831a and sliding of the cam 811b and cam surface 831b. For descriptive convenience, such a pivot form may be expressed as two-step pivot, pivot of the first step corresponds to sliding of the cam 811a and cam surface 831a, and pivot of the second step corresponds to sliding of the cam 811b and cam surface 831b.

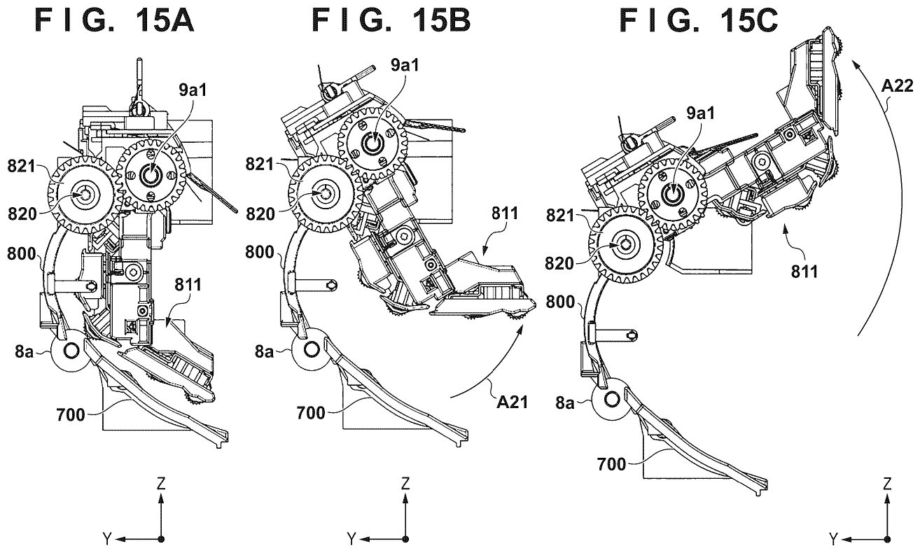

FIGS. 15A, 15B, and 15C are schematic side views showing a state before pivot of the downstream-side upper surface guide portion 811, a state during the pivot, and a state after the pivot from another viewpoint. An arrow A21 in FIG. 15B indicates the locus of pivot of the first step of the downstream-side upper surface guide portion 811, and an arrow A22 in FIG. 15C indicates the locus of pivot of the second step of the downstream-side upper surface guide portion 811.

As indicated by the arrows A21 and A22, the downstream-side upper surface guide portion 811 during pivot draws two types of loci different in the main pivot direction. For example, as is apparent from a comparison between the arrows A21 and A22, the downstream-side upper surface guide portion 811 moves mainly toward the +Z side in pivot of the second step while the Y direction component is suppressed. With this arrangement, the downstream-side upper surface guide portion 811 of a relatively large size can relatively easily pivot to the outside of an apparatus main body 100 via an opening 130 without interfering with another mechanism and the like. According to this embodiment, maintenance of the inside of the apparatus main body 100 can be properly and easily performed.

The support member 810 and the conveyance unit 9 also pivot together with pivot of the downstream-side upper surface guide portion 811 in pivot of the first step, and the shaft portion 9a1 serves as pivot shaft in pivot of the second step. In either pivot, no unnecessary stress is generated on the conveyance unit 9, and for example, the roller 9a and a driven spur 9b are not unnecessarily pressed.

Note that the shaft portion 820 is coaxial with an idler gear 821 for transferring power (rotation) to the roller 9a. When pivoting the support member 810 together with the downstream-side upper surface guide portion 811 and the like, transfer of the power need not be cut off.

### <<Brake/Lock Mechanism>>

The weight of the downstream-side upper surface guide portion 811 is relatively large. For example, when the user incorrectly handles the apparatus, the downstream-side upper surface guide portion 811 during pivot may fall by its own weight. To prevent this, an arrangement in which during and after pivot, the downstream-side upper surface guide portion 811 can be held in a posture at that time is required.

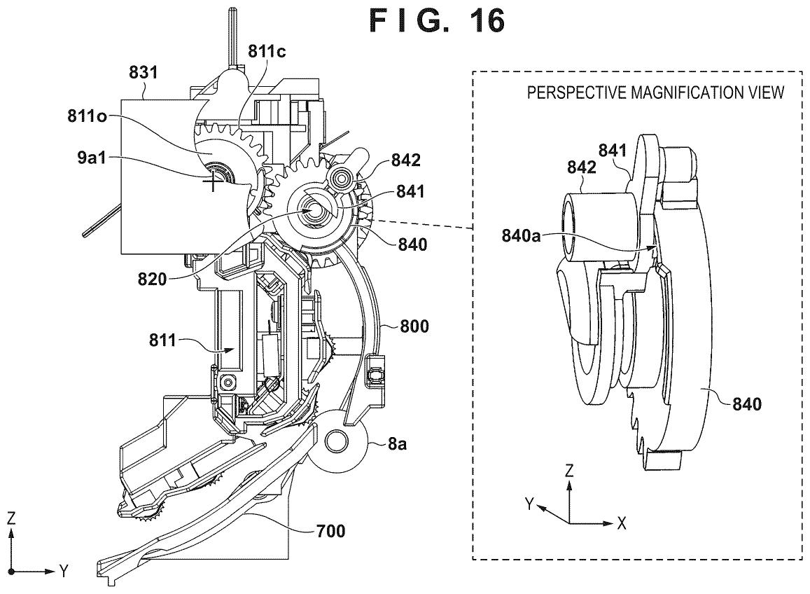

FIG. 16 is a schematic side view including the downstream-side upper surface guide portion 811 and its peripheral portion. In this embodiment, a brake gear 840 that meshes with the gear teeth surface 811c is provided pivotally about the shaft portion 820 serving as a pivot shaft. A convex portion 840a is provided at the peripheral portion of the brake gear 840, and a brake pad 841 that is biased by a biasing unit 842 and can come into contact with the convex portion 840a is provided for the brake gear 840.

When the convex portion 840a contacts the brake pad 841, the brake gear 840 is clamped between the brake pad 841 and the inner side wall 500, and a generated frictional force acts as a braking force with respect to pivot of the downstream-side upper surface guide portion 811.

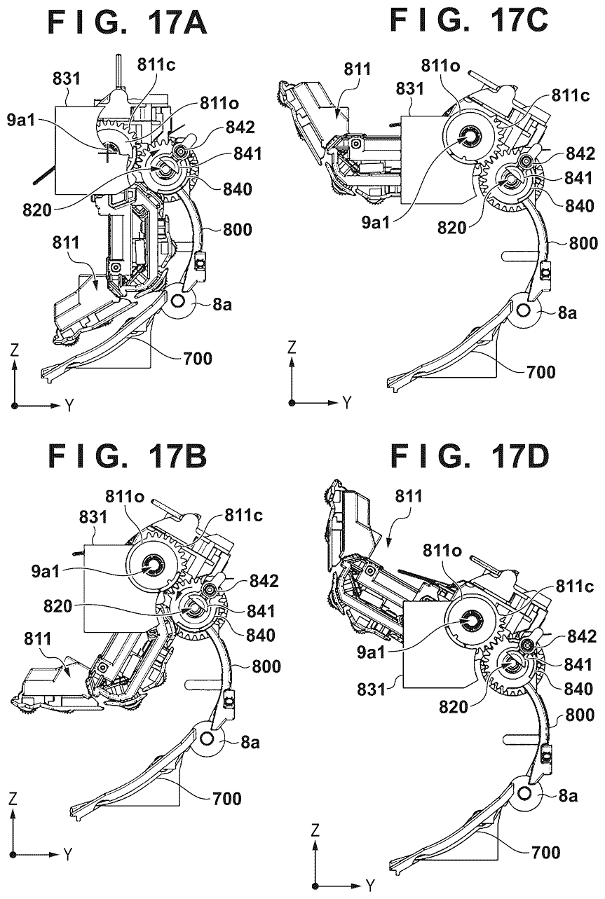

FIG. 17A shows the state of the brake gear 840 before pivot of the first step of the downstream-side upper surface guide portion 811. FIG. 17B shows the state of the brake gear 840 after pivot of the first step of the downstream-side upper surface guide portion 811 and before pivot of the second step. FIG. 17C shows the state of the brake gear 840 during pivot of the second step of the downstream-side upper surface guide portion 811. FIG. 17D shows the state of the brake gear 840 after pivot of the second step of the downstream-side upper surface guide portion 811. During pivot of the downstream-side upper surface guide portion 811, the brake gear 840 rotates in directions indicated by arrows in FIGS. 17A to 17D.

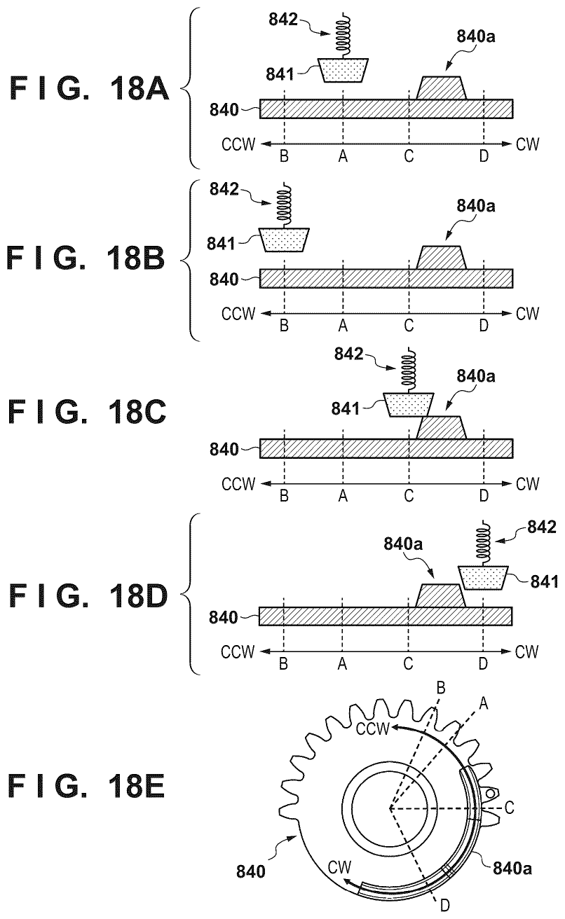

FIG. 18E is a schematic view for explaining the relative position of the brake pad 841 with respect to the brake gear 840 during pivot of the downstream-side upper surface guide portion 811. A position A in FIG. 18E corresponds to the state in FIG. 17A, and represents the relative position of the brake pad 841 before pivot of the first step. A position B in FIG. 18E corresponds to the state in FIG. 17B, and represents the relative position of the brake pad 841 after pivot of the first step and before pivot of the second step. A position C in FIG. 18E corresponds to the state in FIG. 17C, and represents the relative position of the brake pad 841 during pivot of the second step. A position D in FIG. 18E corresponds to the state in FIG. 17D, and represents the relative position of the brake pad 841 after pivot of the second step.

That is, in pivot of the first step of the downstream-side upper surface guide portion 811, the brake pad 841 relatively moves from the position A to the position B in a Counter Clock Wise (CCW) direction. Then, in pivot of the second step, the brake pad 841 relatively moves from the position B to the position C through the position A in a Clock Wise (CW) direction, and further relatively moves to the position D in the CW direction.

FIGS. 18A to 18D are developed views for explaining the positional relationship between the brake gear 840 and the brake pad 841, and correspond to the positions A to D (states in FIGS. 17A to 17D), respectively.

Between the positions B and C including the position A, the convex portion 840a does not contact the brake pad 841, and no braking force is generated with respect to pivot of the downstream-side upper surface guide portion 811. In contrast, between the positions C and D, the convex portion 840a comes into contact with the brake pad 841, generating the braking force.

At the position D, the convex portion 840a moves apart from the brake pad 841, so no braking force is generated, but the brake pad 841 comes closer to the brake gear 840 side than the convex portion 840a because of biasing by the biasing unit 842. Hence, the brake gear 840 is regulated to make it hard that the brake pad 841 relatively moves from the position D and returns to the position C (or the position A or B). With this arrangement, the downstream-side upper surface guide portion 811 is kept locked in a posture after pivot of the second step. The brake gear 840, the brake pad 841, and the biasing unit 842 may be expressed as a brake mechanism and/or a lock mechanism.

### <<Others>>

In the embodiments, each element is named using an expression based on its main function. However, each function described in the embodiments may be a sub-function, and is not strictly limited to the expression. The expression can be replaced with another similar expression. In the same vein, an expression “unit or portion” can be replaced with “tool”, “component”, “member”, “structure”, “assembly”, or the like. Alternatively, these may be omitted or added.

Although “first”, “second”, and the like may be added to elements of similar names, they are used simply for discrimination and do not represent the priority or order.

In addition, two or more elements selectably exemplified in the embodiments are not strictly limited to the exemplification, and may arbitrarily be combined. For example, each of the two or more elements exemplified may be additionally selected or alternatively selected. As an example, when arbitrarily combining two elements A and B, to indicate one of “only A”, “only B”, and “both A and B”, an expression “A and/or B” may be used, or an expression “at least one of A and B”may be used.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-157733 and No. 2024-157735, both filed Sep. 11, 2024, which are hereby incorporated by reference herein in their entirety.

What is claimed is:

1. A printing apparatus comprising:
a housing including an opening provided at an upper portion;
a printing unit arranged in the housing and configured to print on a sheet;
a guide mechanism arranged in the housing and configured to guide the sheet conveyed from the printing unit; and
a cover portion configured to move between a first position at which the opening is opened, and a second position at which the opening is closed,
wherein the guide mechanism includes a first guide portion configured to guide a first surface of the sheet, and a second guide portion arranged to face the first guide portion and configured to guide a second surface of the sheet, and
the first guide portion is configured to be movable to open a conveyance path of the sheet formed between the first guide portion and the second guide portion in a case where the cover portion is at the first position.

2. The apparatus according to claim 1, wherein the cover portion is a tray configured to stack a sheet printed by the printing unit.

3. The apparatus according to claim 1, wherein the first guide portion is movable by a user in an open state of the cover portion.

4. The apparatus according to claim 3, wherein the cover portion is configured to be openable/closable by sliding.

5. The apparatus according to claim 1, further comprising a holding unit configured to hold, in a posture at that time, the first guide portion moved to open the conveyance path.

6. The apparatus according to claim 1, wherein the first guide portion is configured to be pivotal to open the conveyance path.

7. The apparatus according to claim 6, wherein the guide mechanism includes, as the first guide portion, a third guide portion, and a fourth guide portion arranged in line with the third guide portion on a downstream side in a conveyance direction of the sheet with respect to the third guide portion, and
a pivot shaft of the third guide portion is positioned on an upstream side in the conveyance direction, and a pivot shaft of the fourth guide portion is positioned on a downstream side in the conveyance direction.

8. The apparatus according to claim 7, wherein the third guide portion is arranged on the downstream side in the conveyance direction with respect to the printing unit.

9. The apparatus according to claim 8, wherein the pivot shaft of the third guide portion serves as a first pivot shaft,
the third guide portion includes a driven roller having a second pivot shaft different from the first pivot shaft, and
the driven roller is provided to be spaced apart from the conveyance path before pivot of the third guide portion, and move closer to the conveyance path after the pivot of the third guide portion than before the pivot of the third guide portion.

10. The apparatus according to claim 9, wherein the driven roller includes a plurality of driven rollers arranged in a direction of the second pivot shaft.

11. The apparatus according to claim 9, wherein the third guide portion further includes a driven rotation member having a third pivot shaft different from the first pivot shaft and the second pivot shaft, and
the driven rotation member is provided to be close to the conveyance path before pivot of the third guide portion, and move more apart from the conveyance path after the pivot of the third guide portion than before the pivot of the third guide portion.

12. The apparatus according to claim 11, wherein the driven rotation member includes a plurality of driven rotation members arranged in a direction of the third pivot shaft.

13. The apparatus according to claim 1, further comprising a connecting member pivotally connected to the first guide portion at one end portion, and pivotally connected to an inner side wall of the housing at the other end portion.

14. The apparatus according to claim 1, wherein the first guide portion is configured to be slidable to open the conveyance path.

15. The apparatus according to claim 1, wherein the conveyance path includes a first portion that passes through the printing unit and then extends toward one side in a horizontal direction, and a second portion that curves upward from the first portion and extends toward the other side in the horizontal direction.

16. The apparatus according to claim 15, wherein the conveyance path further includes a third portion that extends from below the printing unit toward the other side in the horizontal direction, further curves upward, and extends to the one side in the horizontal direction toward the printing unit.

17. The apparatus according to claim 1, wherein the printing unit includes a printhead configured to discharge ink.

18. The apparatus according to claim 1, wherein the first guide portion includes, as a pivot shaft, two shaft portions different in position from each other, and is configured to be pivotal to open the conveyance path.

19. The apparatus according to claim 18, wherein the two shaft portions include a first shaft portion and a second shaft portion, and
the first guide portion is pivotal between a third position at which the first surface is guidable, and a fourth position at which the conveyance path is opened, pivots about the first shaft portion serving as the pivot shaft from the third position to a fifth position between the third position and the fourth position, and pivots about the second shaft portion serving as the pivot shaft from the fifth position to the fourth position.

20. The apparatus according to claim 19, wherein a component of the horizontal direction from the fifth position to the fourth position is suppressed compared to a component of the horizontal direction from the third position to the fifth position.
